(19) United States
(12) Patent Application Publication
(10) Pub. No.: US 2009/0219381 A1
(43) Pub. Date: Sep. 3, 2009

(54) SYSTEM AND/OR METHOD FOR PROCESSING THREE DIMENSIONAL IMAGES

(75) Inventor: Alfredo M. Ayala, West Covina, CA (US)

Correspondence Address: DISNEY ENTERPRISES, INC;C/O BERKELEY LAW & TECHNOLOGY GROUP, LLP, 17933 NW Evergreen Parkway, Suite 250, BEAVERTON, OR, 97006, US

(73) Assignee: Disney Enterprises, Inc., a Delaware Corporation, Burbank, CA (US)

(21) Appl. No.: 12/359,048

(22) Filed: Jan. 23, 2009

Related U.S. Application Data
(60) Provisional application No. 61/033,169, filed on Mar. 3, 2008.

(51) Int. Cl. H04N 13/02; H04N 7/18; G06K 9/00

(52) U.S. Cl. 348/43; 348/159; 382/154; 348/E09.002

(57) ABSTRACT

The subject matter disclosed herein relates to a method and/or system for projection of images to appear to an observer as one or more three-dimensional images.

### RELATED APPLICATIONS

This application claims the benefit of U.S. Provisional Patent Application No. 61/033,169, filed on Mar. 3, 2008.

### BACKGROUND

1. Field

The subject matter disclosed herein relates to processing images to be viewed by an observer.

2. Information

Three dimensional images may be created in theatre environments by illuminating a reflective screen using multiple projectors. For example, a different two-dimensional (2-D) image may be viewed in each of an observer's eye to create an illusion of depth. Two-dimensional images generated in this manner, however, may result in distortion of portions of the constructed three-dimensional image (3-D). This may, for example, introduce eye strain caused by parallax, particularly when viewing 3-D images generated over large areas.

### BRIEF DESCRIPTION OF THE FIGURES

Non-limiting and non-exhaustive embodiments will be described with reference to the following figures, wherein like reference numerals refer to like parts throughout the various figures unless otherwise specified.

FIG. 1 is a schematic a conventional system for projecting a three-dimensional (3-D) image to be viewed by an observer.

FIG. 2 is a schematic diagram illustrating effects of parallax associated with viewing a projected 3-D image.

FIGS. 3A through 3D are schematic diagrams of a system for projecting a 3-D image over a curved surface according to an embodiment.

FIG. 4 is a schematic diagram of a system of capturing images of an object for projection as a 3-D image according to an embodiment.

FIG. 5 is a schematic diagram of a system for generating composite images from pre-rendered image data and image data captured in real-time according to an embodiment.

FIG. 6 is a schematic diagram of a 3-D imaging system implemented in a theater environment according to an embodiment.

FIG. 7 is a schematic diagram of a system for obtaining image data based, at least in part, on audience members sitting in a theater according to an embodiment.

FIG. 8 is a schematic diagram of a system for processing image data according to an embodiment.

FIG. 9 is a diagram illustrating a process of detecting locations of blobs based, at least in part, on video data according to an embodiment.

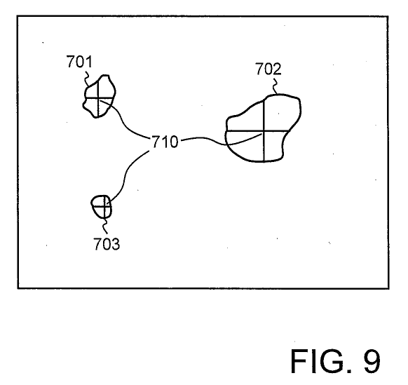

### DETAILED DESCRIPTION

Reference throughout this specification to “one embodiment” or “an embodiment” means that a particular feature, structure, or characteristic described in connection with the embodiment is included in at least one embodiment of claimed subject matter. Thus, the appearances of the phrase “in one embodiment” or “an embodiment” in various places throughout this specification are not necessarily all referring to the same embodiment. Furthermore, the particular features, structures, or characteristics may be combined in one or more embodiments.

According to an embodiment, an observer of a three-dimensional (3-D) image created from projection of multiple two-dimensional (2-D) images onto a reflective screen may experience parallax defined by one or more deviation angles in at least some portions of the 3-D image. Such parallax may be particularly acute as an observer views points on the reflective screen that are farthest from the center of the projected 3-D image. In one embodiment, multiple-projectors may project a 3-D image on a reflective screen from 2-D image data. Here, for example, a projector may project an associated 2-D component of a 3-D image based, at least in part, on digitally processed image data representative of a 2-D image.

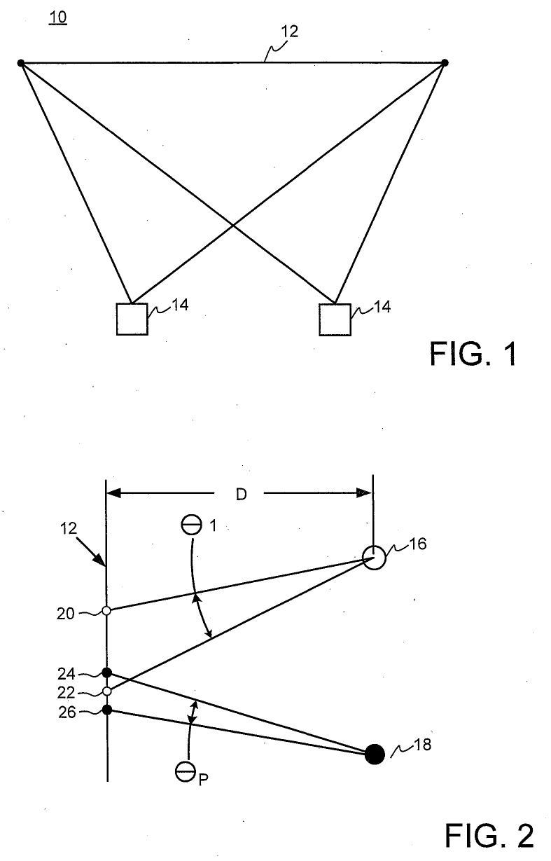

As shown in FIG. 1, projectors 14 may each project a component of an image onto reflective screen 12 which may be perceived by an observer as one or more 3-D images of objects in a theater environment 10. Such 3-D images may comprise images of still or moving objects. In a theater environment, such a 3-D image may be viewable through inexpensive passive polarized glasses acting to interleave multiple 2-D images to appear as the 3-D image. Accordingly, two different views are projected onto screen 12 where each of an observer's eyes sees its own view, creating an impression of depth. Here, such multiple 2-D images may be projected with polarized light such that the reflected images are out of phase by 90 degrees, for example. Alternatively, such a 3-D image may be viewable through active glasses which temporally interleave left and right components (e.g., at 120 Hz.) to appear as the 3-D image.

To create image data for use in projecting such 3-D images, multiple cameras may be positioned to capture an associated 2-D image of a 3-D object. Here, each camera may be used to capture image data representative of an associated 2-D image of the object. Such 2-D images captured by such cameras may then be processed and/or transformed into 2-D components of a 3-D image to be projected by multiple projectors onto a reflective screen as illustrated above.

In viewing a 3-D image generated as discussed above, an observer may see views of the same object that are not horizontally aligned, resulting in parallax. Here, such misalignment of views of the same object may result, at least in part, from placement of multiple projectors to create a 3-D image. For example, a 6.5 cm separation between an observer's eyes may cause each eye to see a different image. Depending on placement of projectors and separation of a viewer's eyes, such a viewer may experience parallax when viewing portions of a resulting 3-D image.

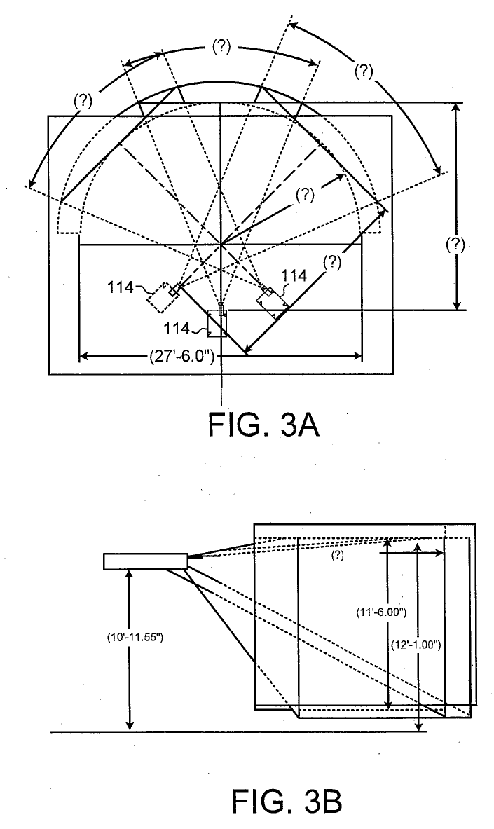

FIG. 2 shows a different aspect of theater environment 10 where reflective screen 12 is flat or planar, and an observer obtains different views of a 3-D object at each eye 16 and 18. Here, eye 16 obtains a view of a first 2-D image bounded by points 20 and 22 while eye 18 obtains a view of a second 2-D image bounded by points 24 and 26. As shown in FIG. 2, such first and second images are horizontally non-aligned and/or skewed on the flat or planar reflective screen 12 as viewed by respective eyes 16 and 18. Accordingly, the observer may experience parallax and/or eye strain.

Briefly, one embodiment relates to a system and/or method of generating a 3-D image of an object. 2-D images of a 3-D object may be represented as 2-D digital image data. 2-D images generated from such 2-D image data may be perceived as a 3-D image by an observer viewing the 2-D images. At least a portion of the 2-D image data may be transformed for projection of associated 2-D images onto a curved surface by, for example, skewing at least a portion of the digital image data. Such skewing of the digital image data may reduce a deviation error associated with viewing a projection of a resulting 3-D image by an observer. It should be understood, however, that this is merely an example embodiment and claimed subject matter is not limited in this respect.

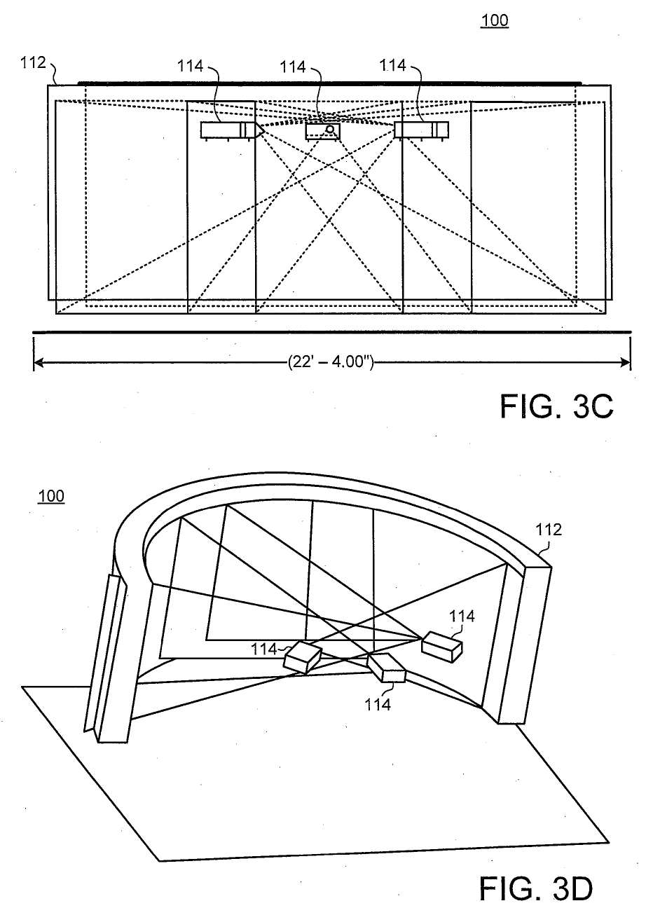

FIGS. 3A through 3D show views of a system 100 for generating 3-D images viewable by an observer facing reflective screen 112. Projectors 114 project 2-D images onto reflective screen 112. The combination of the reflected 2-D images may appear to the observer as a 3-D image. Here, it should be observed that reflective screen 112 is curved along at least one dimension. In this particular embodiment, reflective screen 112 is curved along an axis that is vertical with respect to an observer's sight while projectors 114 are positioned to project associated overlapping images of an object onto reflective screen 112. Further, in the particularly illustrated embodiment, projectors 114 are positioned at height to project images downward and over the heads of observers (not shown). Accordingly, 3-D images may be made to appear in front of such observers, and at below eye level. In a particular embodiment, multiple projectors may be placed such that optical axes of the lens intersect roughly at a single point on a reflective screen at about where an observer is to view a 3-D image. In some embodiments, multiple pairs of projectors may be used for projecting multiple 3-D images over a panoramic scene, where each pair of projectors is to project an associated 3-D image in the scene. Here, for example, each projector in such a projector pair may be positioned such that the optical axes of the lenses in the projector pair intersect at a point on a reflective screen.

As illustrated below, by processing 2-D image data for projection onto such a curved surface, distortions in the resulting 3-D (as perceived by the observer) may be reduced. As referred to herein, a “curved” structure, such as a reflective screen and/or surface, comprises a substantially non-planer structure. Such a curved screen and/or surface may comprise a smooth surface contour with no abrupt changes in direction. In the particular embodiment illustrated in FIGS. 3A through 3D, reflective screen 12 may be formed as a curved screen comprising a portion of a circular cylinder having reflective properties on a concave surface. Such a cylindrical curved screen may have any radius of curvature such as, for example, four feet or smaller, or larger than thirteen feet. In other embodiments, however, a curved screen may comprise curvatures of different geometrical shapes such as, for example, spherical surfaces, sphereoidal surfaces, parabolic surfaces, hyperbolic services or ellipsoidal surfaces, just to name a few examples.

According to an embodiment, projectors 114 may transmit polarized images (e.g., linearly or circularly polarized images) that are 90° out of phase from one another. Accordingly, an observer may obtain an illusion of depth by constructing a 3-D image through glasses having left and right lenses polarized to match associated reflected images. As shown in the particular embodiment of FIGS. 3A through 3D, portions of 2-D images projected onto screen 112 may partially overlap. Here, screen 112 may comprise a gain screen or silver screen having a gain in a range of about 1.8 to 2.1 to reduce or inhibit the intensity of “hot spots” viewed by an observer in such regions where 2-D images overlap, and to promote blending of 2-D images while maintaining polarization

As pointed out above, images viewed through the left and right eyes of an observer (constructing a 3-D image) may be horizontally skewed with respect to one another due to parallax. According to an embodiment, although claimed subject matter is not so limited, image data to be used in projecting an image onto a curved screen (such as screen 112) may be processed to reduce the effects of parallax and horizontal skewing. Here, projectors 114 may project images based, at least in part, on digital image data representative of 2-D images. In a particular embodiment, such digital image data may be transformed for projection of multiple images onto a curved surface appearing to an observer as a 3-D image as illustrated above. Further, such digital image data may be transformed for horizontal de-skewing of at least a portion of the projection of the multiple images as viewed by the observer.

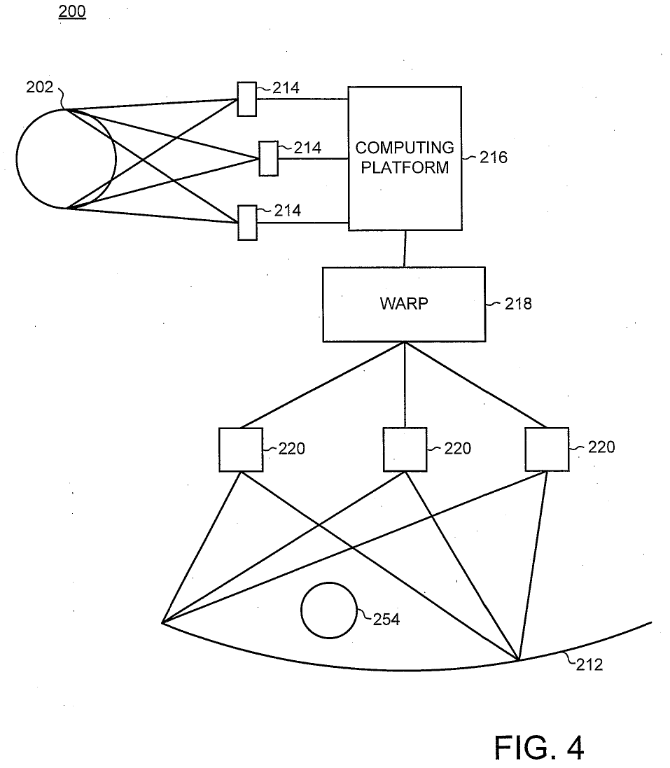

FIG. 4 is a schematic diagram of a system 200 for capturing 2-D images of a 3-D object 202 for use in generating a 3-D image 254. Here, multiple cameras 214 may obtain multiple 2-D images of 3-D object 202 at different angles as shown. Such cameras may comprise any one of several commercially available cameras capable of digitally capturing 2-D images such as high definition cameras sold by Sony, for example. However, less expensive cameras capable of capturing 2-D images may also be used, and claimed subject matter is not limited to the use of any particular type of camera for capturing images.

Digital image data captured at cameras 214 may be processed at computing platform 216 to, among other things generate digital image data representing images to be projected by projectors 220 against a curved reflective screen 212 for the generation of 3-D image 254. In the presently illustrated embodiment, such 2-D images are represented as digital image data in a format such as, for example, color bit-map pixel data including 8-bit RGB encoded pixel data. However, other formats may be used without deviating from claimed subject matter.

Cameras 214 may be positioned to uniformly cover portions of interest of object 202. Here, for example, cameras 214 may be evenly spaced to evenly cover portions of object 202. In some embodiments, a higher concentration of cameras may be directed to portions of object 202 having finer details and/or variations to be captured and projected as a 3-D image. Projectors 220 may be placed to project 2-D images onto screen 212 to be constructed by a viewer as 3-D image 254 as illustrated above. Also, and as illustrated above with reference to FIGS. 3A through 3D, projectors 220 may be positioned so as to not obstruct an observer's view of images on screen 212 viewers in an audience. For example, projectors 220 may be placed over head, at foot level and/or to the side of an audience that is viewing 3-D image 254.

According to an embodiment, cameras 214 may be positioned with respect to object 202 independently of the positions of projectors 220 with respect to screen 212. Accordingly, based upon such positioning of cameras 214 and projectors 220, a warp engine 218 may transform digital image data provided by computing platform 216 relative to placement of projectors 220 to account for positioning of cameras 214 relative to projectors 220. Here, warp engine 218 may employ one or more affine transformations using techniques known to those of ordinary skill in the art. Such techniques applied to real-time image warping may include techniques described in King, D. Southcon/96. Conference Record Volume, Issue 25-27, June 1996, pp. 298-302.

According to an embodiment, computing platform 216 and/or warp engine 218 may comprise combinations of computing hardware including, for example, microprocessors, random access memory (RAM), mass storage devices (e.g., magnetic disk drives or optical memory devices), peripheral ports (e.g., for communicating with cameras and/or projectors) and/or the like. Additionally, computing platform 216 and warp engine may comprise software and/or firmware enabling transformation and/or manipulation of digital image data captured at cameras 214 for transmitting images onto screen 212 through projectors 220. Additionally, while warp engine 218 and computing platform 216 are shown as separate devices in the currently illustrated embodiment, it should be understood that in alternative implementations warp engine 218 may be integrated with computing platform 216 in a single device and/or computing platform.

According to an embodiment, images of object 202 captured at cameras 214 may comprise associated 2-D images formed according to a projection of features of object 202 onto image planes associated with cameras 214. Accordingly, digital image data captured at cameras 214 may comprise pixel values associated with X-Y positions on associated image planes. In one particular implementation, as illustrated above, images projected on to a reflective screen, and originating at different cameras, may be horizontally skewed as viewed by the eyes of an observer. As such, computing platform 216 may process such 2-D image data captured at cameras 214 for projection on to the curvature of screen 212 by, for example, horizontally de-skewing at least a portion of the 2-D image data, thereby horizontally aligning images originating at different cameras 214 to reduce parallax experienced by an observer viewing a resulting 3-D image.

According to an embodiment, a location of a feature of object 202 on an image plane of a particular camera 214 may be represented in Cartesian coordinates x and y which are centered about an optical axis of the particular camera 214. In one particular implementation, and without adjusting for horizontal skew of images, such a location may be determined as follows:

$$λ [ \begin{matrix}x \\ y \\ 1\end{matrix} ] = [ \begin{matrix}- f & 0 & 0 & 0 \\ 0 & - f & 0 & 0 \\ 0 & 0 & 1 & 0\end{matrix} ] [ \begin{matrix}X \\ Y \\ Z \\ 1\end{matrix} ]$$

Where:
X, Y and Z represent a location of an image feature on object 202 in Cartesian coordinates having an origin located on an image plane of the particular camera 214, and where dimension Z is along its optical axis;
x and y represent a location of the image feature in the image plane;
f is a focal length of the particular camera 214; and
λ is a non-zero scale factor.

According to an embodiment, an additional transformation may be applied to 2-D image data captured at a camera 214 (e.g., at computing platform 216) to horizontally de-skew a resulting 2-D image as projected onto reflective screen 212 with respect to one or more other 2-D images projected onto reflective screen 212 (e.g., to reduce the incidence of parallax as viewed by the observer). Here, such a transformation may be expressed as follows:

$$[ \begin{matrix}{x}^{′} \\ {y}^{′} \\ 1\end{matrix} ] = [ \begin{matrix}1 & 0 & {u}_{0} \\ 0 & 1 & {v}_{0} \\ 0 & 0 & 1\end{matrix} ] \times [ \begin{matrix}x \\ y \\ 1\end{matrix} ]$$

Where:
x′ and y′ represent a transformed location of the image feature in the image plane;
u₀ represents an amount that a location is shifted horizontally; and
v₀ represents an amount that a location is shifted vertically.

Here, the value u₀, affecting the value x′, may be selected to horizontally de-skew a resulting projected image from one or more other images viewed by an observer from a reflective screen as discussed above. As pointed out above, projectors may be positioned such that optical axes intersect at a point on a reflected screen to reconstruct two 2-D images as a 3-D image. By adjusting the value of u₀, an effective or virtual optical axis of a 2-D image may be horizontally shifted to properly align 2-D images projected by two different projectors. For example, values of u₀ for images projected by a pair of projectors may be selected such that resulting images projected by the projectors align at a point on a reflective screen at a center between the pair of projectors. While there may be a desire to de-skew images horizontally (e.g., in the direction of x) in a particular embodiment, there may be no desire to de-skew images vertically (e.g., in the direction of y). Accordingly, the value v₀ may be set at zero. Values of u₀ may be determined based on an analysis of similar triangles that are set by the focal length based upon a location of the observer relative to the screen.

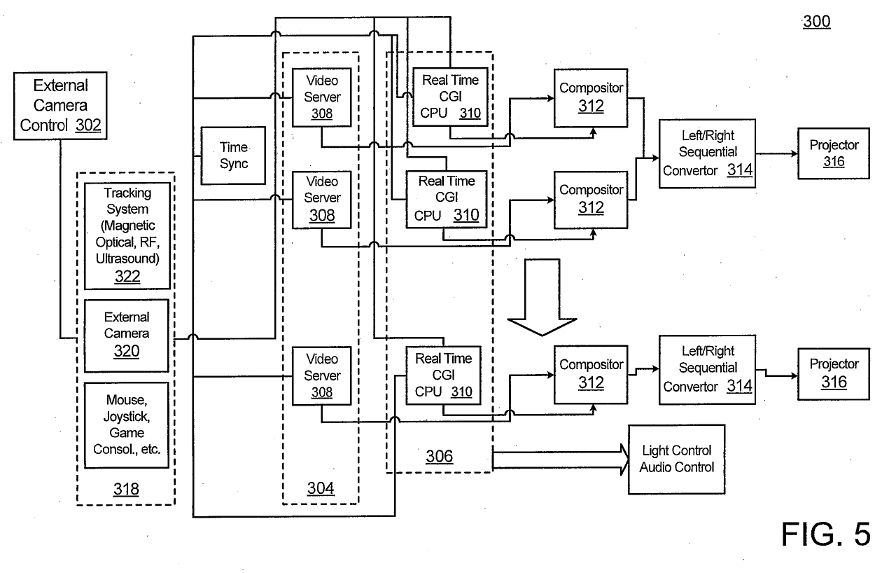

System 200 may be used to project still or moving images of objects onto screen 212 for viewing by an observer as a 3-D image. In one particular embodiment, as illustrated in FIG. 5, real-time images of objects may be projected onto a screen to appear as 3-D images to an observer where at least one portion of the projected image is based upon an image of an object captured in real-time. Here, system 300 may project images onto a screen based, at least in part, on digital image data generated by a pre-render system 304 and generated by real-time imaging system 306.

Projectors 316 may project 2-D images onto a reflective screen (e.g., a curved screen as illustrated above) to be perceived as 3-D images to an observer. In the particularly illustrated embodiment, sequential converters 314 may temporally interleave right and left 2-D images. In an alternative implementation, projectors 316 may transmit left and right 2-D images that are polarized and 90° out of phase, permitting an observer wearing eye glasses with polarized lens to view associated left and right components to achieve the illusion of depth as illustrated above.

According to an embodiment, portions of images generated by pre-render system 304 and generated by real-time imaging system 306 may be digitally combined at an associated compositor 312. Real-time computer generated imagery (CGI) CPUs 310 are adapted process digital image data of images of objects captured at one or more external cameras 320 in camera system 318. For example, real-time CGI CPUs 310 may comprise computing platforms adapted to process and/or transform images of objects using one or more techniques as illustrated above (e.g., to reduce parallax as experienced by an observer). In one embodiment, the one or more external cameras 320 may controlled (e.g., focus, pointing, zoom, exposure time) automatically in response to signals received at tracking system 322. Here, tracking system 322 may include sensors such as, for example, IR detectors, microphones, vibration sensors and/or the like to detect the presence and/or movement of objects which are to be imaged by the one or more external cameras 320. Alternatively, or in conjunction with control from tracking system 322, cameras 322 may be controlled in response to control signals from external camera control 302.

According to an embodiment, pre-render system 304 comprises one or more video servers 308 which are capable of generating digital video images including, for example, images of scenes, background, an environment, animated characters, animals, actors and/or the like, to be combined with images of objects captured at camera 302. Accordingly, such images generated by video servers 308 may complement images of objects captured at camera system 318 in a combined 3-D image viewed by an observer.

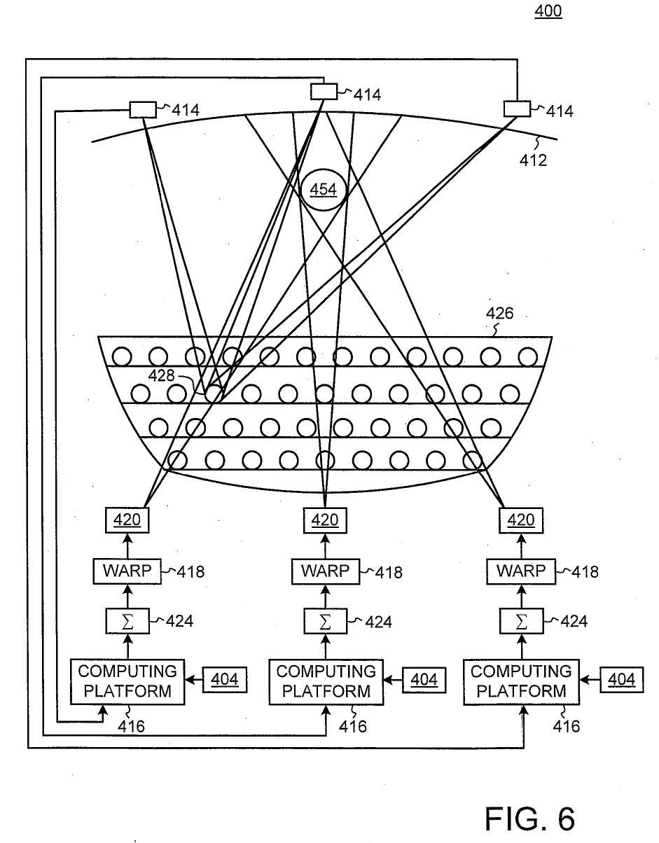

According to a particular embodiment, system 200 may be implemented in a theatre environment to provide 3-D images to be viewed by an audience. For example, system 400 shown in FIG. 6 is adapted to provide 3-D images for viewing by audience members 426 arranged in an amphitheater seating arrangement as shown. As illustrated above according to particular embodiments, projectors 420 may be adapted to project 2-D images onto curved reflective screen 412 to be viewed as 3-D images by audience members 426. Such 2-D images may be generated based, at least in part, on combinations image data provided by pre-render systems 404 and real-time digital image data generated from capture of images of an object by cameras 414, for example. As illustrated above in FIG. 5 according to a particular embodiment, compositors 424 may digitally combine 2-D images processed by associated computing platforms 404 with pre-rendered image data from associated pre-render systems 404.

According to an embodiment, cameras 414 may be placed in a location so as to not obstruct the view of audience members 426 in viewing 3-D image 454. For example, cameras 414 may be placed above or below audience members 426 to obtain a facial view. Similarly, projectors may be positioned overhead to project downward onto curved screen 412 to create the appearance of 3-D image 454.

Digital image data captured at a camera 414 may be processed at an associated computing platform 416 to, for example, reduce parallax as experienced by audience members 426 in viewing multiple 2-D images as a single 3-D image using one or more techniques discussed above. Additionally, combined image data from a combiner 424 may be further processed by an associated warp engine to, for example, account for positioning of a projector 420 relative to an associated camera 414 for generating a 2-D image to appear to audience members 426, along with other 2-D images, as a 3-D image 454.

In one implementation, cameras 414 may be controlled to capture an image of a particular audience member 428 for generating a 3-D image 454 to be viewed by the remaining audience members 426. As illustrated above, cameras 414 may be pointed using, for example, an automatic tracking system and/or manual controls to capture an image of a selected audience member. Here, horizontal de-skewing of 2-D images may be adjusted based on placement of cameras 414 relative to the location of such a selected audience member. For example, parameters linear transformations (such as u₀ discussed above) applied to 2-D image data may respective projection matrices. Pre-rendered image data from associated pre-render systems 404 may be combined with an image of audience member 428 to provide a composite 3-D image 454. Such pre-rendered image data may provide, for example, outdoor scenery, background, a room environment, animated characters, images of real persons and/or the like. Accordingly, pre-rendered image data combined at combiners 424 may generate additional imagery appearing to be co-located with the image of audience member 428 in 3-D image 454. Such additional imagery appearing to be co-located with the image of audience member 428 in 3-D image 454 may include, for example, animated characters and/or people interacting with audience member 428. In addition, system 400 may also generate sound through an audio system (not shown) that is synchronized with the pre-rendered image data for added effect (e.g., voice of individual or animated character that is interacting with an image of audience member 428 recast in 3-D image 454).

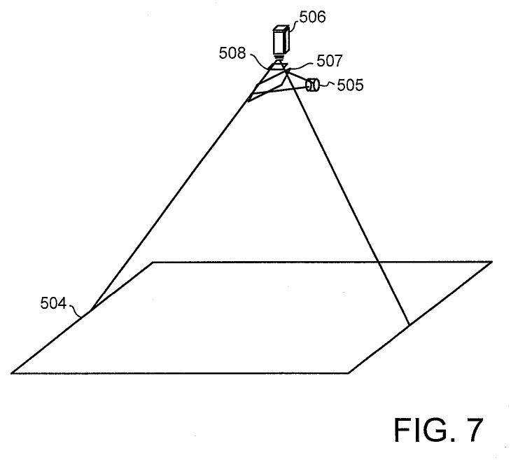

According to an embodiment, system 400 may include additional cameras (not shown) to detect motion of audience members 426. Such cameras may be located, for example, directly over audience members 426. In one particular implementation, such over head cameras may include an infrared (IR) video camera such as IR video camera 506 shown in FIG. 7. Here, audience members (not shown) may generate and/or reflect energy detectable at IR video camera 506. In one embodiment, an audience member may be lit by one or more IR illuminators 505 and/or other electromagnetic energy source capable of generating electromagnetic energy with a relatively limited wavelength range.

IR illuminators 505 may employ multiple infrared LEDs to provide a bright, even field of infrared illumination over area 504 such as, for example, the IRL585A from Rainbow CCTV. IR Camera 506 may comprise a commercially available black and white CCD video surveillance camera with any internal infrared blocking filter removed or other video camera capable of detection of electromagnetic energy in the infrared wavelengths. IR pass filter 508 may be inserted into the optical path of camera 506 optical path to sensitize camera 506 to wavelengths emitted by IR illuminator 505, and reduce sensitivity to other wavelengths. It should be understood that, although other means of detection are possible without deviating from claimed subject matter, human eyes are insensitive to infrared illumination and such infrared illumination may not interfere with visible light in interactive area 504 or alter a mood in a low-light environment.

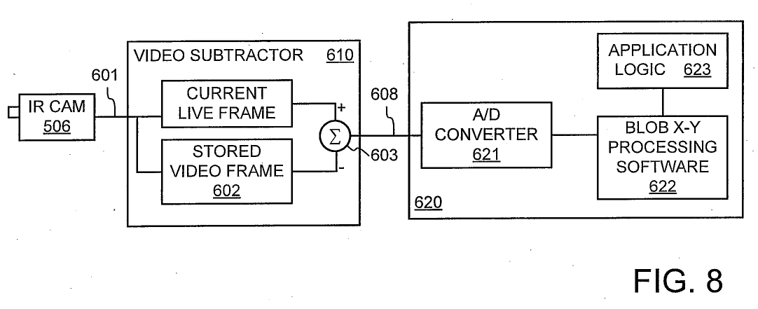

According to an embodiment, information collected from images of one or more audience members captured at IR camera 506 may be processed in a system as illustrated according to FIG. 8. Here, such information may be processed to deduce one or more attributes or features of individuals including, for example, motion, hand gestures, facial expressions and/or the like. In this particular embodiment, computing platform 620 is adapted to detect X-Y positions of shapes or “blobs” that may be used, for example in determining locations of audience members (e.g., audience members 426), facial features, eye location, hand gestures, presence of additional individuals co-located with individuals, posture and position of head, just to name a few examples. Also, it should be understood that specific image processing techniques described herein are merely examples of how information may be extracted from raw image data in determining attributes of individuals, and that other and/or additional image processing techniques may be employed.

According to an embodiment, positions of one or more audience members may be associated with one or more detection zones. Using information obtained from overhead cameras such as IR camera 506, movement of an individual audience member 426 may be detected by monitoring detection zones for each position associated with an audience member 426. As such, cameras 414 may be controlled to capture images of individuals in response to detection of movement of individuals such as, for example, hand gestures. Accordingly, audience members 426 may interact with video content (e.g., from image data provided by pre-render systems 404) and/or interactive elements.

In one particular example, detection of gestures from an audience member may be received as a selection of a choice or option. For example, such detection of a gesture may be interpreted as a vote, answer to a multiple choice question, selection of a food or beverage to be ordered and brought to the audience member's seat and/or the like. In another embodiment, such gestures may be interpreted as request to change presentation, brightness, sound level, environmental controls (e.g., heating and air conditioning) and/or the like.

According to an embodiment, information from IR camera 506 may be pre-processed by circuit 610 to compare incoming video 601 signal from IR camera 506, a frame at a time, against a stored video frame 602 captured by IR camera 506. Stored video frame 602 may be captured when are 504 is devoid of individuals or other objects, for example. However, it should be apparent to those skilled in the art that stored video frame 602 may be periodically refreshed to account for changes in an environment such as area 504.

Video subtractor 603 may generate difference video signal 608 by, for example, subtracting stored video frame 602 from the current frame. In one embodiment, this difference video signal may display only individuals and other objects that have entered or moved within area 504 from the time stored video frame 602 was captured. In one embodiment, difference video signal 608 may be applied to a PC-mounted video digitizer 621 which may comprise a commercially available digitizing unit, such as, for example, the PC-Vision video frame grabber from Coreco Imaging.

Although video subtractor 610 may simplify removal of artifacts within a field of view of camera 506, a video subtractor need not be necessary. By way of example, without intending to limit claimed subject matter, locations of targets may be monitored over time, and the system may ignore targets which do not move after a given period of time until they are in motion again.

According to an embodiment, blob detection software 622 may operate on digitized image data received from A/D converter 621 to, for example, calculate X and Y positions of centers of bright objects, or “blob”, in the image. Blob detection software 622 may also calculate the size of such detected blob. Blob detection software 622 may be implemented using user-selectable parameters, including, but not limited to, low and high pixel brightness thresholds, low and high blob size thresholds, and search granularity. Once size and position of any blobs in a given video frame are determined, this information may be passed to applications software 623 to determine deduce attributes of one or more individuals 503 in area 504.

FIG. 8 depicts a pre-processed video image 608 as it is presented to blob detection software 622 according to a particular embodiment. As described above, blob detection software 622 may detect individual bright spots 701, 702, 703 in difference signal 708, and the X-Y position of the centers 710 of these “blobs” is determined. In an alternative embodiment, the blobs may be identified directly from the feed from IR camera 506. Blob detection may be accomplished for groups of contiguous bright pixels in an individual frame of incoming video, although it should be apparent to one skilled in the art that the frame rate may be varied, or that some frames may be dropped, without departing from claimed subject matter.

As described above, blobs may be detected using adjustable pixel brightness thresholds. Here, a frame may be scanned beginning with an originating pixel. A pixel may be first evaluated to identify those pixels of interest, e.g. those that fall within the lower and upper brightness thresholds. If a pixel under examination has a brightness level below the lower brightness threshold or above the upper brightness threshold, that pixel's brightness value may be set to zero (e.g., black). Although both upper and lower brightness values may be used for threshold purposes, it should be apparent to one skilled in the art that a single threshold value may also be used for comparison purposes, with the brightness value of all pixels whose brightness values are below the threshold value being reset to zero.

Once the pixels of interest have been identified, and the remaining pixels zeroed out, the blob detection software begins scanning the frame for blobs. A scanning process may begin with an originating pixel. If that pixel's brightness value is zero, a subsequent pixel in the same row may be examined. A distance between the current and subsequent pixel is determined by a user-adjustable granularity setting. Lower granularity allows for detection of smaller blobs, while higher granularity permits faster processing. When the end of a given row is reached, examination proceeds with a subsequent row, with the distance between the rows also configured by the user-adjustable granularity setting.

If a pixel being examined has a non-zero brightness value, blob processing software 622 may begin moving up the frame-one row at a time in that same column until the top edge of the blob is found (e.g., until a zero brightness value pixel is encountered). The coordinates of the top edge may be saved for future reference. Blob processing software 622 may then return to the pixel under examination and moves down the row until the bottom edge of the blob is found, and the coordinates of the bottom edge are also saved for reference. A length of the line between the top and bottom blob edges is calculated, and the mid-point of that line is determined. A mid-point of the line connecting the detected top and bottom blob edges then becomes the pixel under examination, and blob processing software 622 may locate left and right edges through a process similar to that used to determine the top and bottom edge. The mid-point of the line connecting the left and right blob edges may then be determined, and this mid-point may become the pixel under examination. Top and bottom blob edges may then be calculated again based on a location of the new pixel under examination. Once approximate blob boundaries have been determined, this information may be stored for later use. Pixels within the bounding box described by top, bottom, left, and right edges may then be assigned a brightness value of zero, and blob processing software 622 begins again, with the original pixel under examination as the origin.

Although this detection software works well for quickly identifying contiguous bright regions of uniform shape within the frame, the detection process may result in detection of several blobs where only one blob actually exists. To remedy this, blob coordinates may be compared, and any blobs intersecting or touch may be combined together into a single blob whose dimensions are the bounding box surrounding the individual blobs. The center of a combined blob may also be computed based, at least in part, on the intersection of lines extending from each corner to the diagonally opposite corner. Through this process, a detected blob list, which may include, but not be limited to including, the center of blob; coordinates representing the blob's edges; a radius, calculated as a mean of the distances from the center of each of the edges for example; and the weight of a blob, calculated as a percentage of pixels within the bounding rectangle which have a non-zero value for example, can be readily determined.

Thresholds may also be set for the smallest and largest group of contiguous pixels to be identified as blobs by blob processing software 622. By way of example, without intending to limit claimed subject matter, where a uniform target size is used and the size of the interaction area and the height of the camera above area 504 are known, a range of valid target sizes can be determined, and any blobs falling outside the valid target size range can be ignored by blob processing software 622. This allows blob processing software 622 to ignore extraneous noise within the interaction area and, if targets are used, to differentiate between actual targets in the interaction area and other reflections, such as, but not limited to, those from any extraneous, unavoidable, interfering light or from reflective clothing worn by an individual 503, as has become common on some athletic shoes. Blobs detected by blob processing software 622 falling outside threshold boundaries set by the user may be dropped from the detected blob list.

Although one embodiment of computer 620 of FIG. 8 may include both blob processing software 622 and application logic 623, blob processing software 622 and application logic 623 may be constructed from a modular code base allowing blob processing software 622 to operate on one computing platform, with the results therefrom relayed to application logic 623 running on one or more other computing platforms.

While there has been illustrated and described what are presently considered to be example embodiments, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular embodiments disclosed, but that such claimed subject matter may also include all embodiments falling within the scope of the appended claims, and equivalents thereof.

What is claimed is:

1. A method comprising:
capturing images of a three-dimensional object at one or more cameras to provide digital image data; and
transforming said digital image data for projection of multiple images onto a curved surface appearing to an observer as a three dimensional image, said transforming said digital image data comprising de-skewing at least a portion of said projection of said multiple images as perceived by said observer.

2. The method of claim 1, wherein said transforming said digital image data further comprises warping said digital image data based, at least in part, on placement of said cameras.

3. The method of claim 2, wherein said warping said digital image data comprises warping said digital image data based, at least in part, on placement of projectors.

4. The method of claim 1, wherein said digital image data comprises image data representative of one or more two-dimensional images, and wherein said de-skewing at least a portion of said projection of said multiple images as perceived by said observer comprises horizontally shifting at least one of said one or more two-dimensional images.

5. The method of claim 4, wherein said horizontally shifting at least one of said two-dimensional images further comprises horizontally shifting said at least one of said one or more two-dimensional images by an amount to reduce parallax experienced by said observer in viewing said multiple images as said three-dimensional image.

6. The method of claim 1, and further comprising projecting said three-dimensional image onto a polarized surface.

7. The method of claim 6, wherein said polarized surface comprises a gain screen having a polarization gain of about 1.8 to 2.1.

8. The method of claim 1, and further comprising combining said digital image data with pre-rendered video data to provide one or more composite images appearing to said observer as said three-dimensional image.

9. A system comprising:
a plurality of cameras adapted to capture images of a three-dimensional object to provide digital image data; and
a computing platform adapted to transform said digital image data for projection of multiple images onto a curved surface appearing to an observer as a three dimensional image, said computing platform being further adapted to de-skew at least a portion of said projection of said multiple images as perceived by said observer.

10. The system of claim 9, wherein said computing platform is further adapted to warp said digital image data based, at least in part, on placement of said cameras and placement of a plurality of projectors adapted to project said multiple images onto said curved screen.

11. The system of claim 9, wherein said computing platform is further adapted to de-skew said at least a portion of said projection by applying a shift to at least a portion of said digital image data.

12. A method comprising:
capturing two-dimensional image data of an audience member in a theater at a plurality of cameras; and
transforming said image data for projection on a screen in said theater as multiple two-dimensional images viewed by other audience members in said theater as a three-dimensional image of said audience member.

13. The method of claim 12, wherein said screen comprises a curved screen and said transforming said digital image data further comprises de-skewing at least a portion of said projection of said multiple images as perceived by said observer.

14. The method of claim 12, and further comprising combining said image data with pre-rendered video data to provide one or more composite images of at least one object appearing to be co-located with said audience member in said three-dimensional image.

15. The method of claim 14, wherein said at least one object appearing to be co-located with said audience member in said three-dimensional image comprises an animated character.

16. The method of claim 14, wherein said at least one object appearing to be co-located with said audience member in said three-dimensional image comprises a person.

17. An apparatus comprising:
means for capturing two-dimensional image data of an audience member in a theater at a plurality of cameras; and
means for transforming said image data for projection on a screen in said theater as multiple two-dimensional images viewed by other audience members in said theater as a three-dimensional image of said audience member.

18. A method comprising:
partitioning a theater audience into a plurality of detection zones;
monitoring said detection zones with images of individuals in said detection zones captured at a plurality of cameras associated with said detection zones; and
interpreting at least one gesture of at least one individual in an associated detection zone based, at least in part, on at least one of said images captured in said detection zone.

19. The method of claim 18, wherein said interpreting said at least one of said gestures comprises interpreting said at least one of said gestures as a selection.

20. The method of claim 19, wherein said selection comprises a vote.

21. The method of claim 19, wherein said selection comprises an order for delivery of a beverage to a location of said at least one individual.

22. The method of claim 18, wherein said interpreting said at least one of said gestures comprises interpreting said at least one of said gestures as a desire to change a sound level in said theater.

23. The method of claim 18, wherein said monitoring further comprises:
receiving infrared images in at least one of said detection zones; and
temporally processing said infrared images in said at least one of said detection zones.

24. An apparatus comprising:
means for partitioning a theater audience into a plurality of detection zones;
means for monitoring said detection zones with images of individuals in said detection zones captured at a plurality of cameras associated with said detection zones; and
means for interpreting at least one gesture of at least one individual in an associated detection zone based, at least in part, on at least one of said images captured in said detection zone.
